(19) United States
(12) Patent Application Publication
(10) Pub. No.: US 2017/0137679 A1
(43) Pub. Date: May 18, 2017

(54) ABRASIVE COMPACTS

(71) Applicants: Geoffrey John DAVIES, Randburg (ZA); Mosimanegape Stephen MASETE, Johannesburg (ZA); John LIVERSAGE, Roodepoort (ZA); James Alexander REID, Randburg (ZA); Anthony Roy BURGESS, Johannesburg (ZA); Gerrard Soobramoney PETERS, Mondeor (ZA)

(72) Inventors: Geoffrey John DAVIES, Randburg (ZA); Mosimanegape Stephen MASETE, Johannesburg (ZA); John LIVERSAGE, Roodepoort (ZA); James Alexander REID, Randburg (ZA); Anthony Roy BURGESS, Johannesburg (ZA); Gerrard Soobramoney PETERS, Mondeor (ZA)

(21) Appl. No.: 15/419,264

(22) Filed: Jan. 30, 2017

Related U.S. Application Data
(63) Continuation of application No. 12/375,617, filed on Feb. 26, 2010, now abandoned.

(30) Foreign Application Priority Data
Jul. 31, 2006 (ZA) 2006/06330

(51) Int. Cl. C09K 3/14; B24D 18/00

(52) U.S. Cl. CPC C09K 3/1409; B24D 18/0009

(57) ABSTRACT

An abrasive compact comprises an ultrahard polycrystalline composite material comprised of ultrahard abrasive particles having a multimodal size distribution and a binder phase. The ultrahard polycrystalline composite material defines a plurality of interstices, the binder phase being distributed in the interstices to form greater than an optimal threshold of binder pools per square micron.

### BACKGROUND OF THE INVENTION

This invention relates to abrasive compacts.

Abrasive compacts are used extensively in cutting, milling, grinding, drilling and other abrasive operations. Abrasive compacts consist of a mass of ultrahard particles, typically diamond or cubic boron nitride, bonded into a coherent, polycrystalline conglomerate. The abrasive particle content of abrasive compacts is high and there is generally an extensive amount of direct particle-to-particle bonding or contact. Abrasive compacts are generally sintered under elevated temperature and pressure conditions at which the abrasive particle, be it diamond or cubic boron nitride, is crystallographically or thermodynamically stable.

Some abrasive compacts may additionally have a second phase which contains a catalyst/solvent or binder material. In the case of polycrystalline diamond compacts, this second phase is typically a metal such as cobalt, nickel, iron or an alloy containing one or more such metals. In the case of PCBN compacts this binder material typically comprises various ceramic compounds.

Abrasive compacts tend to be brittle and in use they are frequently supported by being bonded to a cemented carbide substrate or support. Such supported abrasive compacts are known in the art as composite abrasive compacts. Composite abrasive compacts may be used as such in a working surface of an abrasive tool. The cutting surface or edge is typically defined by the surface of the ultrahard layer that is furtherest removed from the cemented carbide support.

Examples of composite abrasive compacts can be found described in U.S. Pat. Nos. 3,745,623; 3,767,371 and 3,743,489.

Composite abrasive compacts are generally produced by placing the components necessary to form an abrasive compact in particulate form on a cemented carbide substrate. The composition of these components is typically manipulated in order to achieve a desired end structure. The components may, in addition to ultrahard particles, comprise solvent/catalyst powder, sintering or binder aid material. This unbonded assembly is placed in a reaction capsule which is then placed in the reaction zone of a conventional high pressure/high temperature apparatus. The contents of the reaction capsule are then subjected to suitable conditions of elevated temperature and pressure.

It is desirable to improve the abrasion resistance of the ultrahard abrasive layer as this allows the user to cut, drill or machine a greater amount of the workpiece without wear of the cutting element. This is typically achieved by manipulating variables such as average ultrahard particle grain size, overall binder content, ultrahard particle density and the like.

For example, it is well known in the art to increase the abrasion resistance of an ultrahard composite by reducing the overall grain size of the component ultrahard particles. Typically, however, as these materials are made more wear resistant they become more brittle or prone to fracture.

Abrasive compacts designed for improved wear performance will therefore tend to have poor impact strength or reduced resistance to spalling. This trade-off between the properties of impact resistance and wear resistance makes designing optimised abrasive compact structures, particularly for demanding applications, inherently self-limiting.

Additionally, because finer grained structures will typically contain more solvent/catalyst or metal binder, they tend to exhibit reduced thermal stability when compared to coarser grained structures. This reduction in optimal behaviour for finer grained structures can cause substantial problems in practical application where the increased wear resistance is nonetheless required for optimal performance.

Prior art methods to solve this problem have typically involved attempting to achieve a compromise by combining the properties of both finer and coarser ultrahard particle grades in various manners within the ultrahard abrasive layer.

An approach to solving the problem of achieving an optimal marriage of properties between coarser- and finer-grained structures lies in the use of intimate powder mixtures of ultrahard grains of differing sizes. These are typically mixed as homogenously as possible prior to sintering the final compact. Both bimodal distributions (comprising two particle size fractions) and multimodal distributions (comprising three or more fractions) of ultrahard particles are known in the art.

U.S. Pat. No. 4,604,106 describes a composite polycrystalline diamond compact that comprises at least one layer of interspersed diamond crystals and pre-cemented carbide pieces which have been sintered together at ultra high pressures and temperatures. In one embodiment, a mixture of diamond particles is used, 65% of the particles being of the size 4 to 8 μm and 35% being of the size 0.5 to 1 μm. A specific problem with this solution is that the cobalt cemented carbide reduces the abrasion resistance of that portion of the ultrahard layer.

U.S. Pat. No. 4,636,253 teaches the use of a bimodal distribution to achieve an improved abrasive cutting element. Coarse diamond (larger than 3 μm in particle size) and fine diamond (smaller than 1 μm in particle size) is combined such that the coarse fraction comprises 60 to 90% of the ultrahard particle mass; and the fine fraction comprises the remainder. The coarse fraction may additionally have a trimodal distribution.

U.S. Pat. No. 5,011,514 describes a thermally stable diamond compact comprising a plurality of individually metal-coated diamond particles wherein the metal coatings between adjacent particles are bonded to each other forming a cemented matrix. Examples of the metal coating are carbide formers such as tungsten, tantalum and molybdenum. The individually metal-coated diamond particles are bonded under diamond synthesis temperature and pressure conditions. The patent further discloses mixing the metal-coated diamond particles with uncoated smaller sized diamond particles which lie in the interstices between the coated particles. The smaller particles are said to decrease the porosity and increase the diamond content of the compact. Examples of bimodal compacts (two different particle sizes), and trimodal compacts, (three different particles sizes), are described.

U.S. Pat. Nos. 5,468,268 and 5,505,748 describe the manufacture of ultrahard compacts from a mass comprising a mixture of ultrahard particle sizes. The use of this approach has the effect of widening or broadening of the size distribution of the particles allowing for closer packing and minimizing of binder pool formation, where a binder is present.

U.S. Pat. No. 5,855,996 describes a polycrystalline diamond compact which incorporates different sized diamond. Specifically, it describes mixing submicron sized diamond particles together with larger sized diamond particles in order to create a more densely packed compact.

U.S. Pat. Application No. 2004/0062928 further describes a method of manufacturing a polycrystalline diamond compact where the diamond particle mix comprises about 60 to 90% of a coarse fraction having an average particle size ranging from about 15 to 70 μm and a fine fraction having an average particle size of less than about one half of the average particle size of the coarse fraction. It is claimed that this blend results in an improved material behaviour.

The problem with this general approach is that whilst it is possible to improve the wear and impact resistances when compared with either the coarse or fine-grained fraction alone, these properties still tend to be compromised i.e. the blend has a reduced wear resistance when compared to the finer grained material alone and a reduced impact resistance when compared to the coarser grained fraction. Hence the result of using an intimate mixture of particle sizes is simply to achieve the property of the average intermediate particle size.

The development of an abrasive compact that can achieve improved properties of impact and fatigue resistance consistent with coarser grained materials, whilst still retaining the superior wear resistance of finer grained materials, is therefore highly desirable.

### SUMMARY OF THE INVENTION

According to a first aspect of the invention, there is provided an abrasive compact comprising an ultrahard polycrystalline composite material comprised of ultrahard abrasive particles having a multimodal size distribution and a binder phase, the ultrahard polycrystalline composite material defining a plurality of interstices, the binder phase being distributed in the interstices to form binder pools, characterised in that the polycrystalline composite material comprises greater than an optimal threshold of binder pools per square micron.

The invention further provides a method of manufacturing an abrasive compact, including the steps of subjecting a mass of ultrahard abrasive particles in the presence of a binder phase to conditions of elevated temperature and pressure suitable for producing an abrasive compact, the method being characterized by the mass of ultrahard particles having at least two different average particle sizes, which are provided in suitable quantities and relative average particle sizes so as to provide greater than an optimal threshold of binder pools per square micron in the sintered compact.

The abrasive compacts of the invention preferably comprise ultrahard abrasive particles having an overall average particle grain size of less than about 12 μm, preferably less than about 10 μm, and an overall average particle grain size of greater than 2 μm. The optimal threshold in the case of these materials lies at a number of binder pools per square micron that is greater than 0.45, more preferably greater than 0.50 and most preferably greater than 0.55

The ultrahard polycrystalline diamond material is typically in the form of a polycrystalline diamond layer having a layer thickness in excess of 0.5 mm, preferably in excess of 1.0 mm, more preferably in excess of 1.5 mm.

The invention extends to the use of the abrasive compacts of the invention as abrasive cutting elements, for example for cutting or abrading of a substrate or in drilling applications.

### BRIEF DESCRIPTION OF THE FIGURES

FIG. 1 is a graph of binder pools per square micron of various prior art compacts and compacts of the invention; and

FIG. 2 shows images of a compact of the invention compared to a prior art compact after testing.

### DESCRIPTION OF PREFERRED EMBODIMENTS

The present invention is directed to abrasive compacts, in particular ultrahard polycrystalline abrasive compacts, made under high pressure/high temperature conditions. The abrasive compacts are characterised in that the binder phase is distributed in such a manner as to achieve above an optimal threshold number of individual catalyst/solvent or binder pools per unit area in the final structure.

The ultrahard abrasive particles may be diamond or cubic boron nitride, but are preferably diamond particles.

The ultrahard abrasive particle mass will be subjected to known temperature and pressure conditions necessary to produce an abrasive compact. These conditions are typically those required to synthesize the abrasive particles themselves. Generally, the pressures used will be in the range 40 to 70 kilobars and the temperature used will be in the range 1300 to 1600° C.

The abrasive compact, particularly for diamond compacts, will generally comprise polycrystalline abrasive material bonded to a cemented carbide support or substrate forming a composite abrasive compact. To produce such a composite abrasive compact, the mass of abrasive particles will be placed on a surface of a cemented carbide body before it is subjected to the elevated temperature and pressure conditions necessary for compact manufacture.

This invention finds particular application in abrasive compacts that require a polycrystalline diamond layer thickness in excess of 0.5 mm, more preferably in excess of 1.0 mm; and most preferably in excess of 1.5 mm.

The cemented carbide support or substrate may be any known in the art such as cemented tungsten carbide, cemented tantalum carbide, cemented titanium carbide, cemented molybdenum carbide or mixtures thereof. The binder metal for such carbides may be any known in the art such as nickel, cobalt, iron or an alloy containing one or more of these metals. Typically, this binder will be present in an amount of 10 to 20 mass %, but this may be as low as 6 mass %. Some of the binder metal will generally infiltrate the abrasive compact during compact formation.

The ultrahard particles used in the present process can be of natural or synthetic origin. The mixture is multimodal, i.e. comprises a mixture of fractions that differ from one another discernibly in their average particle size. Typically the number of fractions will be either:

a specific case of two fractions

three or more fractions.

By “average particle size” it is meant that the individual particles have a range of sizes with the mean particle size representing the “average”. Hence the major amount of the particles will be close to the average size, although there will be a limited number of particles above and below the specified size. The peak in the distribution of the particles will therefore be at the specified size. The size distribution for each ultrahard particle size fraction is typically itself monomodal, but may in certain circumstances be multimodal. In the sintered compact, the term “average particle grain size” is to be interpreted in a similar manner.

The abrasive compacts produced by the method of the invention additionally have a binder phase present. This binder material is preferably a catalyst/solvent for the ultrahard abrasive particles used. Catalyst/solvents for diamond and cubic boron nitride are well known in the art. In the case of diamond, the binder is preferably cobalt, nickel, iron or an alloy containing one or more of these metals. This binder can be introduced either by infiltration into the mass of abrasive particles during the sintering treatment, or in particulate form as a mixture within the mass of abrasive particles. Infiltration may occur from either a supplied shim or layer of the binder metal or from the carbide support. Typically a combination of the admixing and infiltration approaches is used.

During the high pressure, high temperature treatment, the catalyst/solvent material melts and migrates through the compact layer, acting as a catalyst/solvent and causing the ultrahard particles to bond to one another. Once manufactured, the compact therefore comprises a coherent matrix of ultrahard particles bonded to one another, thereby forming an ultrahard polycrystalline composite material with many interstices or pools containing binder material as described above. In essence, the final compact therefore comprises a two-phase composite, where the ultrahard abrasive material comprises one phase and the binder, the other.

In one form, the ultrahard phase, which is typically diamond, constitutes between 80% and 95% by volume and the solvent/catalyst material the other 5% to 20%.

The relative distribution of the binder phase, and the number of voids or pools filled with this phase, is largely defined by the size and shape of the ultrahard component particles. It is well known in the art that the average grain size of the ultrahard material plays a major role in determining the average binder content. It is postulated that the increased surface area of finer ultrahard particles tends to increase the infiltration of solvent/catalyst metal via capillary action. Hence the overall solvent/catalyst content of finer-grained compacts tends to be higher than that for coarser-grained compacts. Further it is known that the overall binder content can also be manipulated by the use of multimodal abrasive distributions. If the overall binder content for monomodal ultrahard particle distributions is determined by the average ultrahard particle size, then multimodals of the same average grain size will tend to have reduced binder content as a function of their improved packing density.

The effect of the overall content of binder phase occurring in the ultrahard compact is reasonably well understood. The binder phase can help to improve the impact resistance of the more brittle abrasive phase, but as the binder phase typically represents a far weaker and less abrasion resistant fraction of the structure, high quantities will tend to adversely affect wear resistance. Additionally, where the binder phase is also an active solvent/catalyst material, its increased presence in the structure can compromise the thermal stability of the compact.

The effect of the distribution (i.e. the relative individual sizes and distribution thereof) of the binder pools on the properties of the compact is not fully understood. Whilst this can be manipulated to some extent by the composition of the multimodal ultrahard particle mixture, the extent to which manipulating this character can produce desirable properties in the final compact has not previously been known.

It has now been found that by careful choice of the components of the ultrahard particle multimodal mixture, it is possible to achieve a final compact structure where the number of binder pools is maximised over a certain optimal threshold. This optimal threshold has been established for various classes of ultrahard grain sizes. It has been found that maximising the number of pools for compacts which have an average grain size less than 12 μm has a particularly significant effect on the performance of the material. Where comparing prior art compacts with those of this invention therefore, compacts of the invention will tend to have a larger number of individual binder pools, even though they are of similar ultrahard grain size and hence possess a similar overall binder content. Compacts of the invention tend to have an excellent balance of impact resistance and wear resistance when compared with prior art compacts.

Without wishing to be bound by theory, it is postulated that the possible action of binder pools as crack deflectors during chipping or spalling events is significantly more effective when the number of these pools lies above the optimal threshold value of the invention.

A preferred embodiment of the invention provides ultrahard abrasive compacts where the overall average particle grain size is 12 μm or less, or most preferably 10 μm or less. This is an area where the optimal wear resistance of finer grained structures has been found to be most compromised by an inherent susceptibility to impact failure. The lower bound of typical structures of this invention is approximately 2 μm, as many of the structures occurring below this level appear to be strongly influenced by additional factors.

The measurement of the number of binder pools per unit area is carried out on the final compact by conducting a statistical evaluation on a large number of collected images taken on a scanning electron microscope.

It is well known in the art that the magnification selected for the microstructural analysis has a significant effect on the accuracy of the data obtained. Imaging at lower magnifications offers an opportunity to representatively sample larger particles or features in a microstructure; but can tend to under-represent smaller particles or features as they are not necessarily sufficiently resolved at that magnification. By contrast, higher magnifications allow resolution and hence detailed measurement of fine-scale features; but can tend to sample larger features such that they intersect the boundaries of the images and hence are not adequately measured. It is therefore critical to select an appropriate magnification for any quantitative microstructural analysis technique. The appropriateness is therefore determined by the size of the features that are being characterised; and would be evident to those skilled in the art.

The individual binder or catalyst/solvent phase areas or pools, which are easily distinguishable from that of the ultrahard phase using electron microscopy, were identified and counted using standard image analysis tools. An Equivalent Circle Diameter (ECD) is calculated for each identified binder pool. (This measurement technique calculates the diameter of a hypothetical circle that occupies the same area as the area of the binder pool being measured.) For roughly circular binder pools, this is a reasonable estimate of a single quantitative diameter dimension. For the measurement method of this invention, however, the critical values are:

A_{UH}, the total ultrahard abrasive phase area (in square microns)

A_{B}, the total binder phase area (in square microns)

N_{B}, the total number of binder pools that occurred within the area.

The total phase areas were determined by summing the areas of either each individual binder pool or of each ultrahard phase grain within the entire microstructural area that was characterised. The number of binder pools was determined by counting the number of discrete binder areas identified in the microstructural area.

The number of binder pools normalised by the area, N_{B}ⁿ is therefore calculated using:

$${N}_{B}^{n} = \frac{{N}_{B}}{( {A}_{UH} + {A}_{B} )}$$

This number has therefore been normalised against the area of the compact which is being studied at the chosen magnification. The collected distributions of this data is then evaluated statistically; and an arithmetic average is then determined. Hence the average number of binder pools per unit area of microstructure is calculated

In the case of ultrahard compacts of this invention, the average cobalt pool size was determined to be of the order of 1.5-3 μm. This allowed the empirical selection of an appropriate magnification level for the analysis at 3000×. This magnification typically facilitated the successful resolution of individual binder pools, whilst still allowing for larger binder areas to be successfully measured. It was found that the optimal threshold for the number of binder pools per square micron lies at greater than 0.45, more preferably greater than 0.50 and most preferably greater than 0.55.

It is anticipated that microstructural parameters may alter slightly from one area of an abrasive compact to another, depending on formation conditions. Hence the microstructural imaging is carried out so as to representatively sample the bulk of the ultrahard composite portion of the compact.

The multimodal mixture required to produce the abrasive compacts of the invention is characterised in the number of fractions of ultrahard particles employed. This is typically a highly specific bimodal mixture or a multimodal comprising at least three fractions, and preferably four or more.

Where the mixture is bimodal, it typically comprises a coarse fraction and a fine fraction; where the ratio of average particle size between these two fractions is between 2:1 and 10:1, more preferably 3:1 and 6:1. Additionally, the preferred volume fraction of the coarser fraction exceeds 20%; but is less than about 55% and the most preferred at around 50%.

Where the mixture has three or more fractions, it must comprise at least one finer fraction or blend of fractions comprising between 35 and 50 mass % of the total mixture and one coarser fraction or blend of fractions, comprising between 65 and 50 mass % of the mixture, where the average particle grain size of the finest fraction blend is preferably between about ¼ to ⅙ of the average particle grain size of the coarsest fraction blend. Additionally, the ratio between the coarsest single constituent fraction average grain size and the finest single constituent fraction average grain size is at least 8:1, or more preferably 10:1 or most preferably 12:1.

In addition, it has been found that the use of a solvent/catalyst powder additive in the pre-sintered powder mixture can have significant value in achieving the desired end structure, although it is not always required. This is typically introduced at between 0.5 and 3 mass % into the mixture, and most preferably has itself an average particle size less than 2 μm.

This invention is further illustrated by the following non-limiting examples:

EXAMPLE 1

A suitable bimodal diamond powder mixture was prepared. A quantity of sub-micron cobalt powder sufficient to obtain 1 mass % in the final diamond mixture was initially de-agglomerated in a methanol slurry in a ball mill with WC milling media for 1 hour. The fine fraction of diamond powder with an average grain size of 1.5 μm was then added to the slurry in an amount to obtain 49.5 mass % in the final mixture. Additional milling media was introduced and further methanol was added to obtain a suitable slurry; and this was milled for a further hour. The coarse fraction of diamond, with an average grain size of ca. 9.5 μm, was then added in an amount to obtain 49.5 mass % in the final mixture. The slurry was again supplemented with further methanol and milling media, and then milled for a further 2 hours. The slurry was removed from the ball mill and dried to obtain the diamond powder mixture.

The diamond powder mixture was then placed into a suitable HpHT vessel, adjacent to a WC substrate and sintered under conventional HpHT conditions to achieve a final abrasive compact.

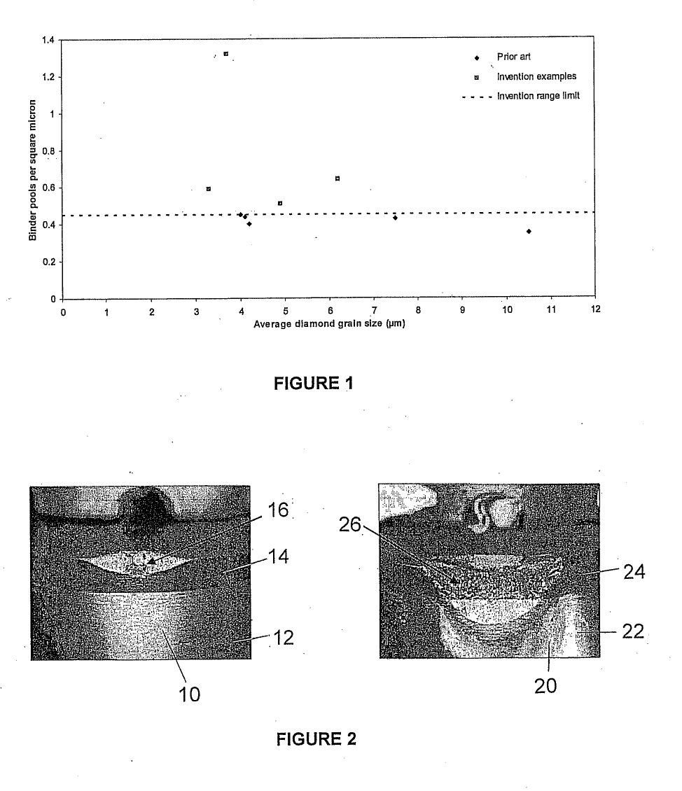

The microstructural characterisation of this material and other physical data is summarised in Table 1 below, and depicted graphically in FIG. 1 in respect of average binder pool size per square micron. This compact was tested in a standard applications-based test where it showed significant performance improvement over that of a prior art compact with a similar average diamond grain size (see comparative example 4). FIG. 2 shows images of the relative performance of this compact 10, which comprises a WC substrate 12 and an ultrahard compact layer 14 having a wear scar 16, against the prior art compact 20 (WC compact 22; ultrahard compact layer 24: wear scar 26) at the same stage in the test, where the increased rate of wear and evidence of chipping of the prior art compact 20 is extremely pronounced.

### EXAMPLES 2 and 3

Examples 2 and 3 were prepared using a similar method to that described in Example 1, save that the sizes of the constituent diamond powders were altered as indicated in Table 1.

TABLE 1

| | | | |
|---|---|---|---|
| | Final | Average | Number of |
| | average | binder | binder |
| | grain size | pool | pools |
| Diamond grain mixture | (μm) | size (μm) | per μm² |

EXAMPLES OF THE INVENTION

| | | | | |
|---|---|---|---|---|
| 1 | BIMODAL: (49.5% 1.5 μm + | 5.4 | 1.82 | 0.64 |
| | 49.5% 9.5 μm) diamond + | | | |
| | 1 mass % Co | | | |
| 2 | BIMODAL: (49.5% 0.7 μm + | 3.7 | 1.61 | 1.32 |
| | 49.5% 4.5 μm) diamond + | | | |
| | 1 mass % Co | | | |
| 3 | MULTIMODAL: (5% 0.7 μm + | 4.9 | 2.05 | 0.51 |
| | 20% 1.5 μm + 11% 2.9 μm + | | | |
| | 48% 4.5 μm + 16% 9.5 μm) | | | |
| | diamond + 1 mass % Co | | | |

PRIOR ART COMPARATIVE EXAMPLES

| | | | | |
|---|---|---|---|---|
| 4 | MONOMODAL: 4.5 μm | 4.2 | 2.33 | 0.40 |
| | diamond + 1 mass % Co | | | |
| 5 | MULTIMODAL: (25% 9.5 | 7.5 | 2.02 | 0.43 |
| | μm + 25% 6 μm + 50% 2.9 | | | |
| | μm) | | | |
| 6 | MULTIMODAL: 5 modes | 10.5 | 2.32 | 0.35 |
| 7 | MULTIMODAL: (12% 9.5 | 5 | 2.3 | 0.37 |
| | μm + 69% 4.5 μm + 18% 2.9 | | | |
| | μM) + 1 mass % Co | | | |

1. An abrasive compact comprising an ultrahard polycrystalline composite material comprised of ultrahard abrasive particles having a multimodal particle size distribution and an overall average particle grain size of less than about 12 μm and greater than about 2 μm, and a binder phase, the ultrahard polycrystalline composite material defining a plurality of interstices, the binder phase being distributed in the interstices to form binder pools, characterised in that there are greater than 0.45 binder pools per square micron.

2. An abrasive compact according to claim 1, wherein the number of binder pools is greater than 0.50 per square micron.

3. An abrasive compact according to claim 1, wherein the number of binder pools is greater than 0.55 binder pools per square micron.

4. An abrasive compact according to claim 1, wherein the ultrahard abrasive particles are diamond.

5. An abrasive compact according to claim 1, wherein the ultrahard abrasive particles are diamond and the ultrahard polycrystalline diamond material is in the form of a polycrystalline diamond layer having a layer thickness in excess of 0.5 mm.

6. An abrasive compact according to claim 5, wherein the polycrystalline diamond layer thickness is in excess of 1.0 mm.

7. An abrasive compact according to claim 5, wherein the polycrystalline diamond layer thickness is in excess of 1.5 mm.
